(19) United States
(12) Patent Application Publication
(10) Pub. No.: US 2024/0126378 A1
(43) Pub. Date: Apr. 18, 2024

(54) FLOATING TRAMPOLINE-STYLE KEYBOARD STRUCTURE

(71) Applicant: Eastern Times Technology Co., Ltd., Dongguan City (CN)

(72) Inventor: Hang Lu, Dongguan City (CN)

(21) Appl. No.: 18/453,318

(22) Filed: Aug. 22, 2023

(30) Foreign Application Priority Data
Oct. 14, 2022 (CN) 202222710047.X

(51) Int. Cl. G06F 3/02; H01H 13/7065; H01H 13/83

(52) U.S. Cl. CPC G06F 3/0202; H01H 13/7065; H01H 13/83; H01H 2233/07

(57) ABSTRACT

A floating trampoline-style keyboard structure, comprising a keyboard panel, a PCB board, and a keyboard base. The keyboard base includes a housing chamber. The PCB board is accommodated within the keyboard base cover and has a first gap with the bottom surface of the keyboard base cover. The keyboard panel is located above the PCB board and closes the opening, and the PCB board and the keyboard panel have a second gap. Several first avoidance holes are provided on the keyboard panel, and several second avoidance holes are provided on the PCB board. A plurality of limit screws are inserted into the first and second avoidance holes in sequence and then locked at the bottom surface of the keyboard base, which restricts the keyboard panel and PCB board from axially disengaging from the keyboard base.

### TECHNICAL FIELD

This invention relates to the field of keyboards, especially to a floating trampoline-style keyboard structure.

### BACKGROUND ART

The keyboard shells available in the market are all fixed, that is, the keyboard cover and the keyboard bottom cover are locked by screws, and the cover cannot move up and down relative to the bottom cover. After the keyboard cover and the keyboard bottom cover are assembled, there is a large gap between the installed PCB board and the keyboard cover and bottom cover. This gap forms a resonance cavity, similar to the structure of a speaker. During the process of striking the keyboard, the keyboard shell will resonate due to the impact, causing noise for the user.

### SUMMARY

In order to solve the above problems, this invention provides a structure that can solve this problem well. This structure can eliminate gap noise and enhance the comfort of the hand feel, it's a floating trampoline-style keyboard structure.

In order to achieve the above objectives, the technical scheme adopted by this invention is as follows:

A floating trampoline-style keyboard structure comprising a keyboard panel, a PCB board, and a keyboard bottom case, wherein the keyboard bottom case has an upwardly open accommodating cavity; the PCB board is accommodated within the keyboard bottom case and has a first gap with a bottom surface of the keyboard bottom case; the keyboard panel is located above the PCB board and seals an opening; the PCB board and the keyboard panel have a second gap; a plurality of first avoidance holes are provided on the keyboard panel; a plurality of second avoidance holes are provided on the PCB board; a plurality of limiting screws are sequentially inserted into the first avoidance holes and the second avoidance holes and then locked on the bottom surface of the keyboard bottom case to prevent the keyboard panel and PCB board from disengaging from the keyboard bottom case in the axial direction; a first elastic body and a second elastic body are respectively provided between the first gap and the second gap.

More preferably, wherein the diameters of the first avoidance holes and the second avoidance holes are larger than the diameter of the limiting screws.

More preferably, each of the plurality of limiting screws from top to bottom successively includes a head, an insertion part, and a locking part; the bottom surface of the keyboard bottom case has a threaded hole; the locking part is locked in the threaded hole; the insertion part is interspersed between the keyboard panel and PCB board and exposed outside the threaded hole, the diameter of the head is larger than the diameter of the first avoidance hole and the head is exposed outside of the first avoidance hole, the surface of the insertion part is smooth and untapped, and the surface of the locking part has external threads and is tapped at a bottom end.

More preferably, wherein the keyboard panel has a plurality of switch shaft holes, and the PCB board is fixed to a plurality of switch shafts; the switch shaft is interspersed in the switch shaft hole, and the keycap is press-fitted on the switch shaft.

More preferably, wherein the keyboard panel has an indicator light hole, and an indicator light connected to the PCB board is installed in the indicator light hole.

More preferably, wherein the keyboard bottom case includes a detachable left side panel, a right side panel, and a keyboard bottom cover; the left side panel and the right side panel are located on both sides of the keyboard bottom cover; the left side panel, the right side panel, and the keyboard bottom cover enclose to form the keyboard bottom case with an opening.

More preferably, wherein the keyboard bottom cover has a pair of height-adjustable stands at one end away from an operator, and a pair of anti-slip pads at one end near the operator.

More preferably, wherein the left side panel is equipped with a USB-C slot, an operating system switch slot, and a working mode switch slot; the USB-C slot, the operating system switch slot, and the working mode switch slot are respectively equipped with a USB-C interface, an operating system switch module, and a working mode switch module the USB-C interface, the operating system switch module, and the working mode switch module are connected to the PCB board respectively.

More preferably, wherein the right side panel is equipped with a storage compartment slot; a press-out storage compartment is slidably installed in the storage compartment slot; the storage compartment is used for storing a wireless receiver.

The beneficial effects of this invention are as follows: This invention provides a floating trampoline-style keyboard structure. When the keyboard is struck, there will be a subtle sinking, not instability. The keyboard panel and the switch shaft are tightly fitted on the elastic body. When the keyboard keys are pressed with force, they will compress downwards and rebound quickly, which prevents the sound of striking keycaps from echoing and can effectively reduce the resonance noise in the keyboard gap, achieving the purpose of eliminating noise. At the same time, the built-in elastic body can effectively change the rigid touch of striking keycaps, improve comfort, and this structure is not limited by the layout of the keyboard or the number of keys (switch shaft and keycaps).

### BRIEF DESCRIPTION OF THE DRAWINGS

FIG. 1 is a structural diagram of the present invention;

FIG. 2 is a top view of FIG. 1;

FIG. 3 is a bottom view of FIG. 1;

FIG. 4 is a left side view of FIG. 1;

FIG. 5 is a right side view of FIG. 1;

FIG. 6 is a cross-sectional view;

FIG. 7 is an enlarged view of portion A in FIG. 6;

FIG. 8 is an exploded view of the present invention;

FIG. 9 is an enlarged view of portion B in FIG. 6;

FIG. 10 is an enlarged view of portion C in FIG. 6.

FIG. 11 is a diagram of the limiting screw in the present invention.

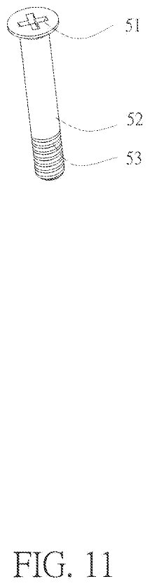

### DETAILED DESCRIPTION OF THE EMBODIMENTS

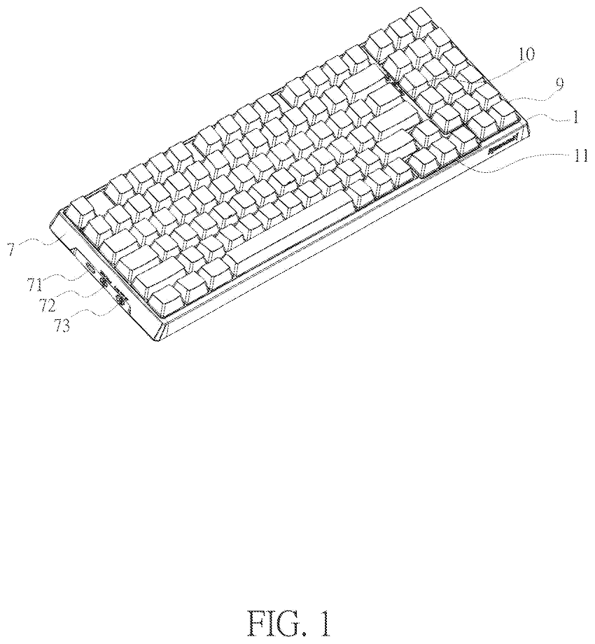

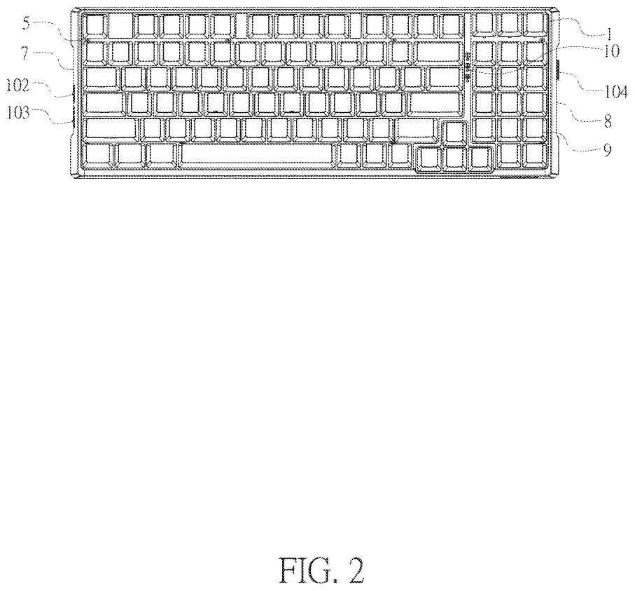

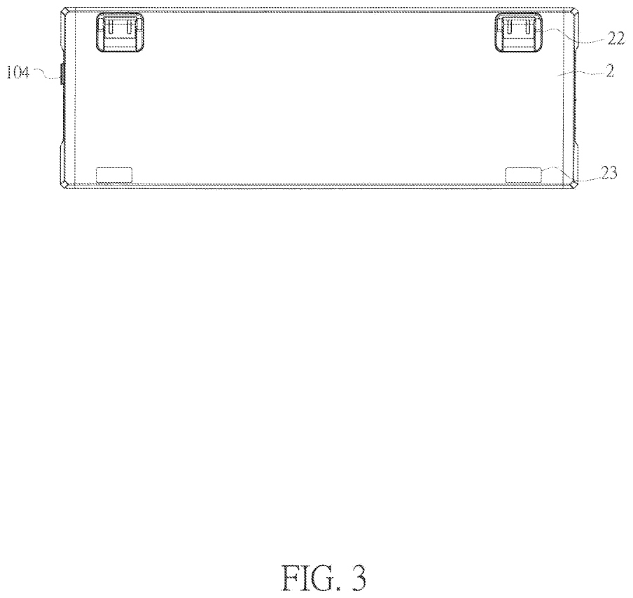

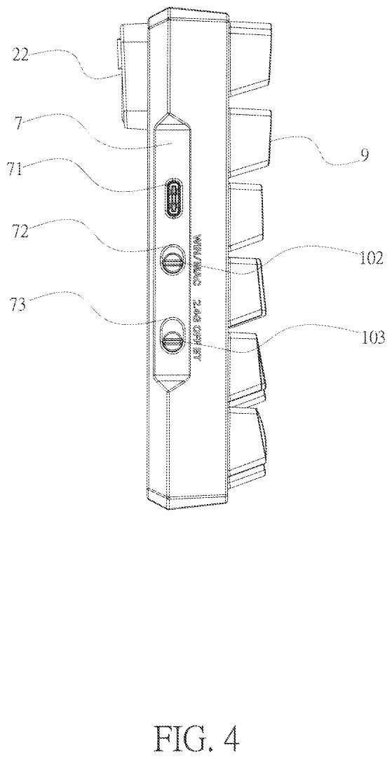

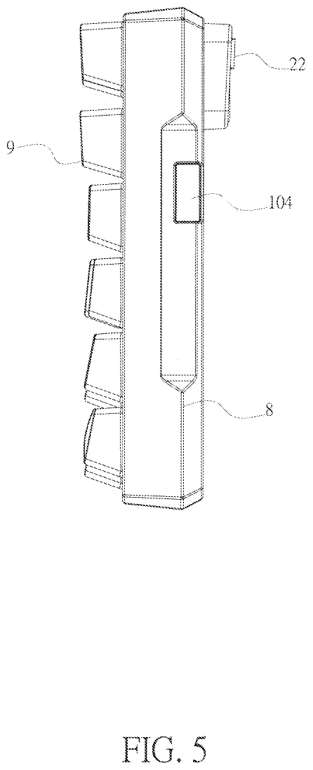

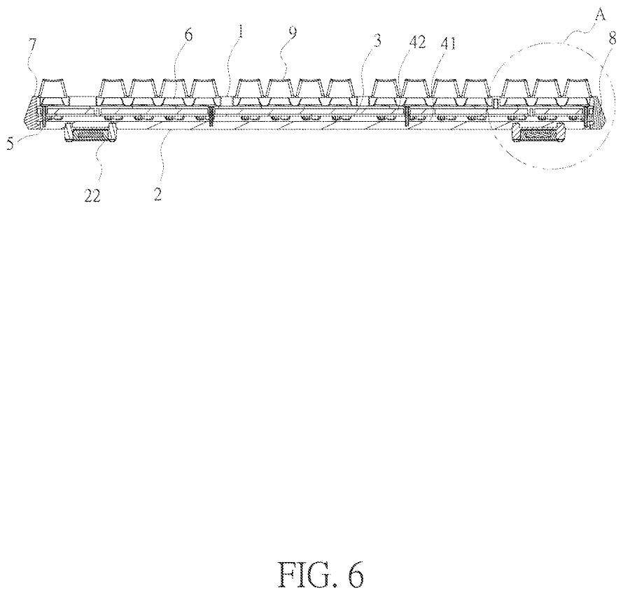

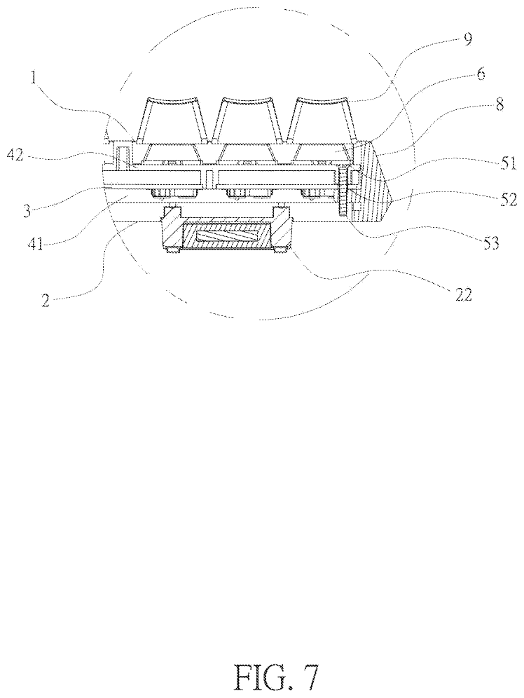

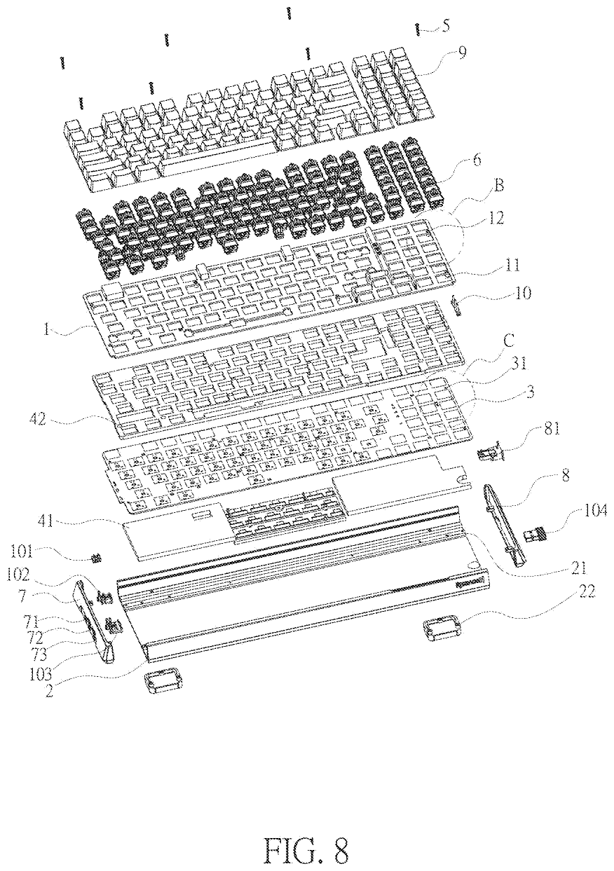

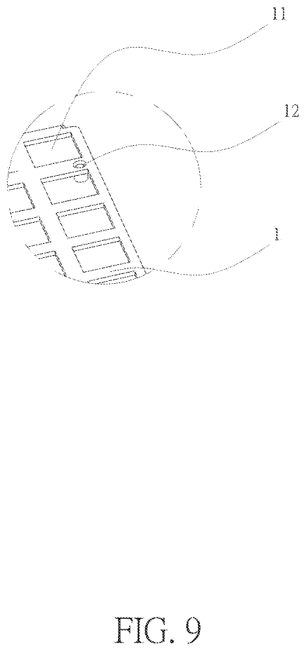

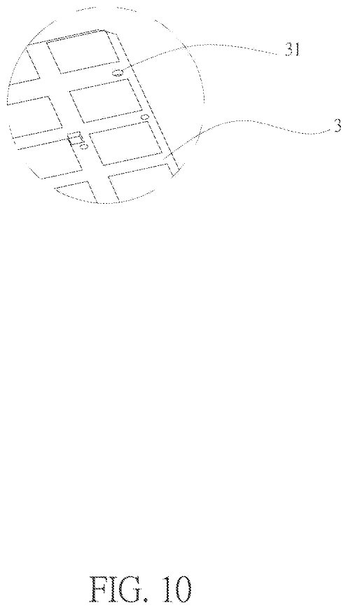

As shown in FIGS. 1-10, the present invention relates to a floating trampoline-style keyboard structure for various mechanical shaft keyboards, including a keyboard panel 1, a PCB board 3, and a keyboard bottom case. The keyboard bottom case has an upwardly open accommodating cavity. The PCB board 3 is accommodated within the keyboard bottom cover 2 and has a first gap with the bottom surface of the keyboard bottom cover 2. The keyboard panel 1 is located above the PCB board 3 and seals the opening. The PCB board 3 and the keyboard panel 1 have a second gap. A plurality of first avoidance holes 12 are provided on the keyboard panel 1. A plurality of second avoidance holes 31 are provided on the PCB board 3. A plurality of limiting screws 5 are sequentially inserted into the first avoidance holes 12 and the second avoidance holes 31 and then locked on the bottom surface of the keyboard bottom case to prevent the keyboard panel 1 and PCB board 3 from disengaging from the keyboard bottom case in the axial direction. A first elastic body 41 and a second elastic body 42 are respectively provided between the first gap and the second gap.

In this embodiment, the diameters of the first avoidance hole 12 and the second avoidance hole 31 are larger than the diameter of the limiting screw 5.

In this embodiment, each of the plurality of limiting screws 5 from top to bottom successively includes a head 51, an insertion part 52, and a locking part 53. The bottom surface of the keyboard bottom case has a threaded hole 21. The locking part 53 is locked in the threaded hole 21. The insertion part 52 is interspersed between the keyboard panel 1 and PCB board 3 and exposed outside the threaded hole 21. The head 51 abuts above the keyboard panel 1. The surface of the insertion part 52 is smooth and not threaded. The surface of the locking part 53 has external threads and the bottom end is threaded. The keyboard panel 1 and PCB board 3 can move up and down relative to each other, and the keyboard panel 1 and PCB board 3 can also move up and down relative to the keyboard bottom case. Therefore, when the keycap 9 is struck, the keycap 9 touches the PCB board 3 through the switch shaft 6, and the PCB board 3 can slightly bounce down. Due to the effect of the elastic body, the PCB board 3 bounces between the keyboard panel 1 and the keyboard bottom case. When the PCB board 3 descends, the keyboard panel 1 descends with it, causing the keyboard panel 1 to bounce slightly. The elastic body acts as a buffer, allowing the keyboard panel 1 and PCB board 3 to bounce slightly like a trampoline without generating noise.

The amount of limiting screws 5 is determined according to the number of keys on the keyboard, as the number of keys will change the layout and size of the keyboard, thereby changing the amount of screws. In this embodiment, eight limiting screws 5 penetrate the keyboard panel 1 and PCB board 3 and are locked on the keyboard bottom case. The limiting screws 5 restrict the highest height of the keyboard panel 1 away from the keyboard bottom case, but do not lock the keyboard panel 1 downward. The eight limiting screws 5 play a role in the keyboard panel 1, preventing the keyboard panel 1 from slipping off. Firstly, the keyboard panel 1, PCB board 3, and the keyboard bottom case are fixed through the limiting screws 5, so that the components can be disassembled and connected, which is convenient for assembly and maintenance, and improves production efficiency. Secondly, the invention provides a keyboard structure in which the elastic body is installed between the PCB board 3 and the keyboard panel 1, and between the PCB board 3 and the keyboard bottom case. The first elastic body 41 supports the PCB board 3, and the second elastic body 42 supports the keyboard panel 1, switch shaft 6, and keycap 9. The original hollow echo area (the first gap and the second gap) is filled with the first elastic body 41 and the second elastic body 42, which can reduce vibration and mute the sound while giving a subtle sinking feeling (about 0.5 mm) when striking the keycap 9, making the keyboard panel 1 and PCB board 3 bounce slightly like a floating trampoline.

In this embodiment, the keyboard panel 1 has a plurality of switch shaft holes 11, and the PCB board 3 is fixed to a plurality of switch shafts 6. The switch shaft 6 is interspersed in the switch shaft hole 11, and the keycap 9 is press-fitted on the switch shaft 6. Striking the keycap 9 causes the switch shaft 6 to move up and down, and the switch shaft 6 touches the PCB board 3 to generate a key switch signal. The signal is processed by a microcontroller (MCU) to communicate with the computer and send the corresponding keystroke signal. When the keycap 9 is struck with force, the elastic body subtly sinks and rebounds to reset, eliminating the gap noise.

In this embodiment, the keyboard panel 1 has an indicator light hole 10, and an indicator light 10 connected to the PCB board 3 is installed in the indicator light hole 10.

In this embodiment, the keyboard bottom case includes a detachable left side panel 7, a right side panel 8, and a keyboard bottom cover 2. The left side panel 7 and the right side panel 8 are located on both sides of the keyboard bottom cover 2. The left side panel 7, the right side panel 8, and the keyboard bottom cover 2 enclose to form a keyboard bottom case with an opening.

In this embodiment, the keyboard bottom cover 2 has a pair of height-adjustable stands 22 at one end away from the operator, and a pair of anti-slip pads 23 at one end near the operator.

In this embodiment, the left side panel 7 is equipped with a USB-C slot 71, an operating system switch slot 72, and a working mode switch slot 73. The USB-C slot 71, the operating system switch slot 72, and the working mode switch slot 73 are respectively equipped with a USB-C interface, an operating system switch module 102, and a working mode switch module 103. The USB-C interface, the operating system switch module 102, and the working mode switch module 103 are connected to the PCB board 3 respectively.

In this embodiment, the right side panel 8 is equipped with a storage compartment slot 81. A press-out storage compartment is slidably installed in the storage compartment slot 81. The storage compartment is used for storing the wireless receiver 104; the press-out is an existing technology, i.e., when the storage compartment is pressed, it can pop out from the storage compartment slot 81, facilitating the user to take and store the wireless receiver 104.

The above embodiments are only a description of the preferred embodiments of the present invention and are not intended to limit the scope of the present invention. Without departing from the spirit of the present invention, all variations and improvements made by those skilled in the

I claim:

1. A floating trampoline-style keyboard structure comprising
a keyboard panel, a PCB board, and a keyboard bottom case,
wherein the keyboard bottom case has an upwardly open accommodating cavity;
the PCB board is accommodated within the keyboard bottom case and has a first gap with a bottom surface of the keyboard bottom case;
the keyboard panel is located above the PCB board and seals an opening;
the PCB board and the keyboard panel have a second gap;
a plurality of first avoidance holes are provided on the keyboard panel;
a plurality of second avoidance holes are provided on the PCB board;
a plurality of limiting screws are sequentially inserted into the first avoidance holes and the second avoidance holes and then locked on the bottom surface of the keyboard bottom case to prevent the keyboard panel and PCB board from disengaging from the keyboard bottom case in the axial direction;
a first elastic body and a second elastic body are respectively provided between the first gap and the second gap.

2. The floating trampoline-style keyboard structure according to claim 1, wherein the diameters of the first avoidance holes and the second avoidance holes are larger than the diameter of the limiting screws.

3. The floating trampoline-style keyboard structure according to claim 1, each of the plurality of limiting screws from top to bottom successively includes a head, an insertion part, and a locking part; the bottom surface of the keyboard bottom case has a threaded hole; the locking part is locked in the threaded hole; the insertion part is interspersed between the keyboard panel and PCB board and exposed outside the threaded hole, the diameter of the head is larger than the diameter of the first avoidance hole and the head is exposed outside of the first avoidance hole, the surface of the insertion part is smooth and untapped, and the surface of the locking part has external threads and is tapped at a bottom end.

4. The floating trampoline-style keyboard structure o according to f claim 1, wherein the keyboard panel has a plurality of switch shaft holes, and the PCB board is fixed to a plurality of switch shafts; the switch shaft is interspersed in the switch shaft hole, and the keycap is press-fitted on the switch shaft.

5. The floating trampoline-style keyboard structure according to claim 1, wherein the keyboard panel has an indicator light hole, and an indicator light connected to the PCB board is installed in the indicator light hole.

6. The floating trampoline-style keyboard structure according to claim 1, wherein the keyboard bottom case includes a detachable left side panel, a right side panel, and a keyboard bottom cover; the left side panel and the right side panel are located on both sides of the keyboard bottom cover; the left side panel, the right side panel, and the keyboard bottom cover enclose to form the keyboard bottom case with an opening.

7. The floating trampoline-style keyboard structure according to claim 6, wherein the keyboard bottom cover has a pair of height-adjustable stands at one end away from an operator, and a pair of anti-slip pads at one end near the operator.

8. The floating trampoline-style keyboard structure according to claim 6, wherein the left side panel is equipped with a USB-C slot, an operating system switch slot, and a working mode switch slot; the USB-C slot, the operating system switch slot, and the working mode switch slot are respectively equipped with a USB-C interface, an operating system switch module, and a working mode switch module the USB-C interface, the operating system switch module, and the working mode switch module are connected to the PCB board respectively.

9. The floating trampoline-style keyboard structure according to claim 6, wherein the right side panel is equipped with a storage compartment slot; a press-out storage compartment is slidably installed in the storage compartment slot; the storage compartment is used for storing a wireless receiver.
